(19) United States
(12) Patent Application Publication
(10) Pub. No.: US 2003/0019736 A1
(43) Pub. Date: Jan. 30, 2003

(54) System and method for producing energy from distilled dry grains and solubles

(76) Inventor: Daniel T. Garman, Eveleth, MN (US)

Correspondence Address: Jason R. Kraus, Dorsey & Whitney LLP, 220 South Sixth Street, Minneapolis, MN, 55402-1498, US

(21) Appl. No.: 10/165,042

(22) Filed: Jun. 6, 2002

Related U.S. Application Data
(60) Provisional application No. 60/296,241, filed on Jun. 6, 2001.

(51) Int. Cl. B01D 3/00

(52) U.S. Cl. 203/23; 203/19

(57) ABSTRACT

The present invention provides a system and method for utilizing DDGS by-products from an ethanol plant. In one embodiment, the DDGS is burned to release thermal energy, which is used to produce steam needed for the operation of the ethanol plant. This method can realize approximate 67% savings in the fuel cost over the conventional propane-fueled ethanol plant.

### PRIORITY CLAIM

This application claims the benefit of Provisional Application Serial No. 60/296,241, filed on Jun. 6, 2001.

### BACKGROUND OF THE INVENTION

This invention relates to a system and method for producing energy from distillation by-products, specifically distilled dried grains and solubles (“DDGS”). More particularly, the present invention relates to utilizing DDGS produced in an ethanol plant to fuel equipment, such as a steam boiler or dryer, in an ethanol plant.

The steadily increasing demand for liquid fuels and the shrinking resources for petroleum crude oil have prompted researchers to investigate alternative liquid fuels and the feasibility of producing such substitutes at the commercial level. The recent, sharp increase in the cost of gasoline and the political instability of many oil-producing countries have demonstrated the vulnerability of present sources of liquid fuels. There is a need in our society to transition to plentiful and renewable fuel resources.

One of the most recognized gasoline fuel substitutes which could be produced at a commercial level is ethanol. (See “The report of the Alcohol Fuels Policy Review” (Dept. of Energy/PE-0012, June 1979)). The federal government recognizes ethanol as a cleaner burning fuel than gasoline. Ethanol currently supplies 1.3 percent of the nation's motor fuel. Most ethanol is sold as a gasoline-blended product (so-called “gasohol”) having about 10 percent ethanol. Some ethanol is sold as a gasoline-blended product (so-called “E85”) having about 85 percent ethanol.

Another clean energy source for the future is biomass energy. Biomass is organic matter, such as wood, crops, and animal wastes. Biomass energy comes from the sun and is stored in plants through photosynthesis. It can be used to generate electricity, heat, or liquid fuels for cars such as ethanol, or other alcohol fuels. Biomass is probably the most underutilized renewable resource in the United States today. It currently provides about 4% of the energy produced in the United States, but some observers believe it could easily supply 20%. Methods of utilizing biomass energy, either by direct combustion or gasification, are known in the prior art. For example, U.S. Pat. No. 4,378,208 discloses a biomass gasifier combustor, and U.S. Pat. No. 4,217,878 discloses a biomass-fueled furnace.

The United States presently has 54 plants for the production of fuel ethanol, of which 45 are use corn-derived processes and the remaining 9 utilize other feedstocks. All of these plants rely on propane or natural gas as the fuel source to operate steam boilers and the product dryers. The price of propane and natural gas has doubled in recent years and is projected to continue to rise. This has dramatically reduced the profit level of these ethanol plants and other plants in other industries. The demand for ethanol, however, continues to increase. In 2000, United States ethanol plants produced 1.6 billion gallons of ethanol, double the 800 million gallons produced in 1989. About forty new ethanol plants are currently under construction in the United States to keep up with the increasing demand for ethanol fuel.

Besides being a fuel source, ethanol is used in the beverage and other industries. The examples of industrial uses of ethanol include the ethanol ingredient in perfumes, aftershaves and cleaners. The ethanol to be used in beverages must meet strict production standards because it is used for human consumption.

Although the process of making ethanol varies slightly for the different grades of ethanol, the main steps involved in the ethanol production are the same. Two somewhat different processes, wet and dry milling, are used to manufacture ethanol. Wet milling currently provides ⅔ of the U.S. ethanol production, and the remaining ⅓ is derived from the dry milling plants.

Ethanol production by dry milling yields certain by-products, including DDGS. However, to the extent uses can be made of the DDGS or other byproducts, ethanol production can become a no-waste process that adds value to the corn by converting it into other valuable products. Agricultural scientists have discovered new value-added markets from the extract of the corn fiber by-product in the wet milling process. For example, U.S. Pat. No. 5,843,499 disclosed a new corn fiber oil which can reduce serum cholesterol level; and U.S. Pat. No. 6,147,206 disclosed a new corn fiber gum which can be used in a variety of applications. A primary uses of the DDGS by products is as a feed. Because of the high content of protein and other nutrients, ninety percent of the by-product DDGS from the dry-milling plants is currently being sold as a supplement in cattle feed at about $0.04 per pound. The remainder is sold as lawn fertilizers.

Bringing the DDGS by-product to other uses involves significant material handling and shipping issues. A small ethanol plant (18 mmgy) produces about 150 tons of DDGS per day. Thus, while the possible uses of DDGS keep it from being a pure waste disposal problem, marketing, storage, and transportation issues must be addressed for the ethanol plant to convert the by-product into value.

Energy use in a typical ethanol plant is a major operating expense and contributes a significant percentage of the cost of fuel ethanol. A primary energy use is thermal energy for generating steam, which is used as the primary medium of heat transfer in the ethanol plant. Steam is used in cooking and fermenting mash and in boiling beer to evaporate ethanol. Steam or hot combustion gases are used in drying stillage produced during the ethanol production. Steam is usually generated in a boiler system which consists of a furnace with heat exchange coils to conduct water through the combustion chamber where it is turned into steam. The steam is then conveyed by pipes to the locations within the ethanol plant where it is to be used as a source of thermal energy.

There is a need in the art for an alternative use for DDGS to help make ethanol plants more economical feasible. There is a further need for a system and method of reducing the conventional energy cost of operating an ethanol plant.

### BRIEF SUMMARY OF THE INVENTION

The present invention, in one embodiment, provides a method of utilizing the stillage by-product or DDGS produced in the ethanol plant as a fuel source for the operation of the plant. The advantage obtained with the invention is to use the ethanol solid residues in a higher value application, namely as a main fuel for the generation of the thermal energy needed for the operation of the plant. The use of DDGS fuel enables more economical operation of the ethanol plant as compared with other conventional fuels, such as natural gas or coal.

While multiple embodiments are disclosed, still other embodiments of the present invention will become apparent to those skilled in the art from the following detailed description, wherein is shown and described only the embodiments of the invention, by way of illustration, of the best modes contemplated for carrying out the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 shows a block diagram of an ethanol plant system adapted to utilize DDGS by-product as a fuel source to provide thermal energy for the production of ethanol.

FIG. 2 shows a block diagram of a multi-fuel burner, according to one embodiment of the present invention.

### DETAILED DESCRIPTION

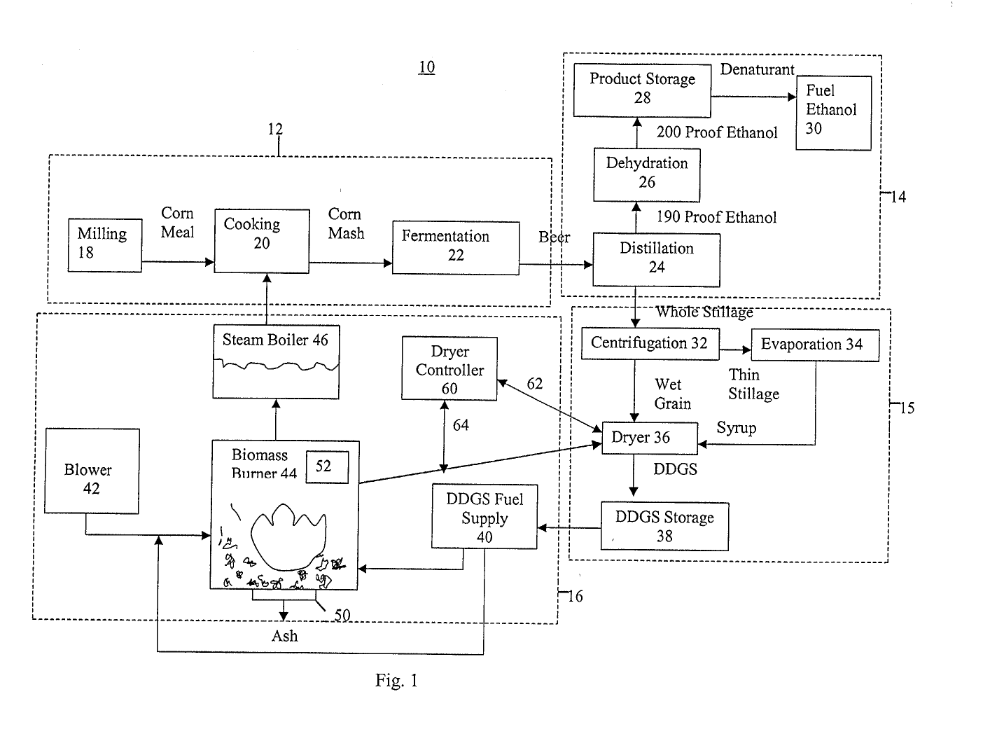

FIG. 1 shows a block diagram of an ethanol producing system 10 for utilizing DDGS by-product as a fuel source to provide thermal energy for the production of ethanol. Certain individual components of the system 10 are present in conventional ethanol plants. Other components are not conventional in ethanol plants but are generally known in the combustion art or materials handling art, or require minimum modification from those currently available in those arts.

FIG. 1 shows application of the invention in a dry milling ethanol plant. As shown in FIG. 1, the ethanol producing system 10 include four sub-systems: a fermentation sub-system 12, a distillation and dehydration sub-system 14, a byproduct handling and processing sub-system 15, and a biomass burner sub-system 16. The biomass burner sub-system 16 and its coordination with the other subsystems are the focus of the present invention.

In the fermentation sub-system 12, feed corn (or other grain) is milled in a milling zone 18. The milled corn is then discharged into a cooking zone 20 for liquefaction and saccharification. The meal is mixed with water and alpha-amylase to make a mash that pass to and through cookers where the starch is liquefied. Heat from the burner 16 is applied at cooking zone 20 to enable liquefaction. Cookers with a high temperature stage (120-150 degrees Celsius) and a lower temperature holding period (95 degrees Celsius) are used. The high temperatures help reduce bacteria levels in the mash. The mash from the cookers is then cooled and the secondary enzyme (gluco-amylase) is added to convert the liquefied starch to fermentable sugars (dextrose), a process called saccharification.

The resulting sugary mass of “corn mash” is discharged into a fermentation zone 22 to produce fermented mash, In the fermentation zone 22, yeast is added to the mash to ferment the sugars to ethanol and carbon dioxide. Using a continuous process, the fermenting mash is allowed to flow, or cascade, through several fermenters until the mash is fully fermented and then leaves the final tank. In a batch fermentation process, the mash stays in one fermenter for about 48 hours before the distillation process is started. The fermented mash from either process is called “beer,” and contains ethanol in the concentration range from 8% to about 12%. The mash contains as well all the non-fermentable solids from the corn and the yeast cells. The mash/beer is then ready to be pumped to the continuous flow, multi-column distillation sub-system 14 where the alcohol is removed from the solids and the water. In one embodiment, further thermal energy is added in the fermentation zone 22 to facilitate fermentation.

Upon completion of the fermentation reaction, mash/beer is flowed into the distillation and dehydration sub-system 14, which contains the distillation zone 24 and a dehydration zone 26. The ethanol is concentrated to 190 proof using conventional distillation and is then dehydrated to approximately 200 proof in a molecular sieve system. Upon dehydration the dried ethanol is stored in the product storage zone 28 and is “doctored” with a denaturant before it is sold as a fuel ethanol 30. After the anhydrous ethanol is blended with about 5% denaturant, it is ready for shipment to gasoline terminals or retailers. Left behind at the distillation zone 24 is the stillage, i.e., the wet grain mash by-product.

The whole stillage is moved into the by-product handling and processing sub-system 15 wherein the wet grain is separated from the thin stillage at the centrifugation zone 32. The stillage is separated into a coarse grain fraction and a “soluble” fraction by centrifugation. The soluble fraction is concentrated to about 30% solids by evaporation. The thin stillage liquid is led to the evaporation zone 34 to be concentrated into the syrup, which is then mixed with the coarse grain from the centrifuge and co-dried in the dryer 36. The coarse grain and syrup fractions are then co-dried to produce the DDGS by-product. The resulting DDGS is discharged to the DDGS storage zone 38.

The biomass burner sub-system 16 replaces the conventional burner that provides heat to the steam boiler 46 and may also provide a hot gas, via dryer heat supply, for use in the dryer 36. In the biomass burner sub-system 16, the DDGS is moved from the DDGS storage zone 38 to the DDGS fuel supply bin 40. A blower 42 forces air into the biomass burner 44 where the DDGS is being burned. The heated air or combustion by-products then reach the steam boiler 46 where steam is generated from water. The steam provides thermal energy needed for the other sub-systems such as the cooking zone 20 and fermentation zone 22. The steam can also be used instead of the hot combustion gases to deliver thermal energy to the dryer 36.

The DDGS storage is used to hold DDGS that can be sold for feed uses or used as fuel for the biomass burner sub-system 16. From a materials handling viewpoint, it is important to provide a means to deliver all the DDGS need for biomass burner sub-system 16 to a fuel supply 40 from which appropriate fuel volume can be delivered to burner 44. In one embodiment, the DDGS is supplied to the biomass burner 44 using a screw feeder coupled to the DDGS fuel supply bin 40. In another embodiment, the DDGS is supplied using a conveyor system, which directly carries the DDGS from the supply bin 40 to the burner 44. In a furtherr embodiment, the DDGS is transported to the blower 42 and blown into the biomass burner 44 through the blower 42. In another embodiment, the DDGS is made into a powder, which is then is transported to the blower 42 and blown into the burner 44. In another embodiment, the DDGS is pelletized and then supplied to the burner 44 by screw feeder or conveyer. In all of these situations, the DDGS is used essentially at its point or origin, thus avoiding the transport expense and associated pollution that would follow from its transport elsewhere for a food supplement or any other use.

In one embodiment, the biomass burner contains an ash grate or dump system 50 for disposal of ash for soil coverage as low-level fertilizer or landfill waste. In one embodiment, the biomass burner 44 includes an emissions control system 52, such as a filtration system to process the emission of burned material. In another embodiment, the emissions control system 52 of the biomass burner 44 is an electro-static precipitator to remove particulates from emissions.

Table 1 shows that using DDGS as a fuel source can provide significant cost savings over the use of propane. Propane contains higher calorific value than DDGS does on per pound basis, in a ratio of about 2.5:1, depending on the extent to which the DDGS is dried. To produce the equivalent thermal energy, about 2.5 pounds of the DDGS fuel are required for every pound of the propane fuel. The cost for 2.5 pounds of DDGS is about $0.10 and that for one pound of propane is about $0.30. The cost for utilizing DDGS as a fuel source is therefore ⅔ less than that for propane. Calculations show that if a plant were to burn DDGS as opposed to propane, it could save about $3.8 million per year.

TABLE 1

| | DDGS | Propane |
|---|---|---|
| Daily Production (Ibs.) | 300,000 | — |
| Calorific value per Ib. | 8625 BTU at 12% | 21785.7 BTU |
| | moisture content. | |
| Calorific value available | 2,587,500,000 BTU | — |
| per day | | |
| Energy required for the | 1,219,969,500 BTU | 1,219,969,500 BTU |
| plant operation per day | | |
| Fuel supply needed | 70 tons | 13,333 gal. |
| Unit cost | $85/ton, or $0.04/Ib. | $1.25/gal, or $0.30/Ib. |
| Daily fuel cost | $5,950.00 | $16,667.00 |

The DDGS is typically dried to about 12% moisture content, which as shown above, produces a calorific value of 8625 BTU per pound. However, greater or lesser drying is possible. In one embodiment, the DDGS is dried essentially completely and then burned as a fuel. When completely dried, the DDGS has a thermal energy value of 9860 BTU per pound. The increase in BTU content presents opportunities to improve the economic effectiveness of the present invention. A dryer controller 60 can be introduced, with a first sensing and control link 62 to the dryer 36 and a second sensing and control link to control the supply of hot combustion gases (or steam) to the dryer 36. This permits regulation of the extent of drying and thus the amount of heat energy diverted from biomass burner 44 for that purpose. By controlling the amount of heat delivered to the dryer 36, or the residence time of the wet grain mass in the dryer 36, or both, the desired level of dryness can be selectively achieved. The amount of residence time of the wet grain mass in the dryer can be controlled by adjusting the feed rate, if the dryer operates on a continuous basis. This permits a higher BTU value to be achieved at a known cost in terms of diversion of heat energy and possible delay in delivery of DDGS out of the dryer 36. The dryer controller 60 permits optimization of DDGS dryness according to the operator's desires and specific conditions, such as any effect on burner efficiency or emissions from the burner 44 that may be dependent on the degree of dryness of DDGS.

In one embodiment, the burner 44 contains a two-step combustion system utilizing primary and secondary chambers, as known in the art. In one embodiment, the burner is a hybrid-fuel burner capable of burning biomass and natural gas or propane delivered at gas supply 48. In one embodiment, the burner is a multi-fuel hybrid series boiler specifically designed to utilize a wide range of standard and alternative fuels. One example of such a burner is the burner commercially available from Hurst Boiler & Welding Company, Inc. of Coolidge, Ga.

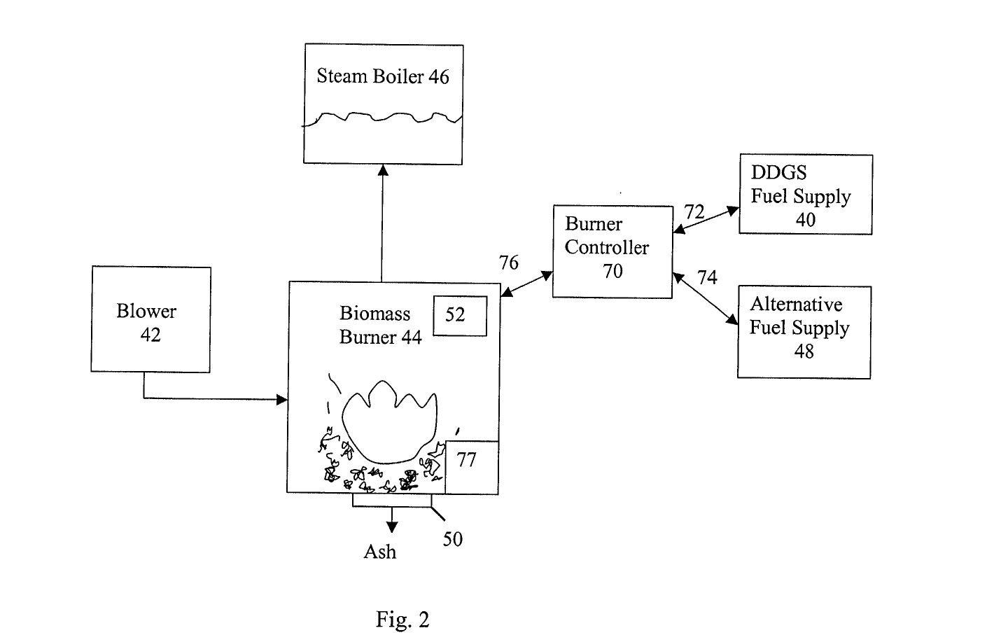

As shown in FIG. 2, in one embodiment of the present invention, a burner controller 70 is used to provide further opportunities to make efficient use of the heat energy available in the DDGS. The burner controller 70 has a first sensing and control link 72 to the fuel supply 40, a second sensing and control link 74 to an alternative fuel supply 48 and a communication link 76 to a sensor module 77 located within the burner 44. The burner 44 also includes a sensor module 52, which measures any desired combustion and combustion by-product parameters (e.g., temperature, gas concentrations and flows, emissions content) within the burner 44.

In one embodiment, burner controller 70 determines the amount and blend of fuel (i.e., DDGS from fuel supply 40 and propane or other gas from alternative fuel supply 48) used in burner 44. This ratio of DDGS to alternative fuels can be adjusted by the burner controller 70 to address fuel needs at start-up, when there may not yet be any or sufficient DDGS available to fuel burner 44 and during steady state operation when emissions considerations, blower air temperature, or other parameters of burner 44 make it desirable to deliver selective amounts and blends of DDGS and any alternative fuel that is fed to burner 44.

In one embodiment of the present invention, both the dryer controller 60 (shown in FIG. 1) and the burner controller 70 (shown in FIG. 2) are used to optimize overall efficiency of the burner sub-system 16, and thus the overall ethanol plant.

Many of the larger ethanol producers make ethanol from a wet-milling process. The first step in wet milling is to steep, or soak, the kernels in water to soften and swell them. After steeping with sulfites for 2 days at 140° F., the soft kernels break into four products, the germ, starch, a high-protein product, and the hull, or fiber. The starch is then further processed to produce ethanol and other products. The present invention is also applicable to this form of ethanol production. Thus, in another embodiment, condensed distillers solubles (CCDS) extracted from the wet-milling ethanol plants are used as a biomass fuel source for a biomass burner that delivers heat energy for use in the wet milling process. Because they contain 48% moisture, in this embodiment, the CCDS requires more drying before it is burned as a fuel than DDGS. In this environment, greater amounts of heat must be delivered via dryer heat supply 45 to dryer 36 (or its equivalent in a wet milling process). Here dryer controller 60 will have a more significant role in selecting the degree of dryness desired to increase BTU content of the dried CCDS, in view of the greater diversion of heat that might otherwise be delivered to the steam boiler 46 (or its equivalent in a wet milling process).

The optimizing techniques described above, in the context of dry-milling ethanol plants, may be employed in wet-milling plants as well.

Although the present invention has been described with reference to preferred embodiments, persons skilled in the art will recognize that changes may be made in form and detail without departing from the spirit and scope of the invention.

I claim:

1. A method of operating an ethanol plant by using a DDGS by-product of an ethanol plant to fuel the steam boiler and dryer of the ethanol plant, the method comprising:
draining a stillage from a fermentation or distillation unit into a dryer;
drying said stillage;
storing said dried stillage into a by-product receiving vessel;
loading said DDGS into a biomass burner;
burning said DDGS to release thermal energy;
directing said thermal energy to a steam boiler; and
generating a hot steam to provide energy needed for operation of the ethanol plant.

2. The method of claim 1 further comprising controlling a time of drying of the stillage and controlling an amount of thermal energy provided during drying.

3. The method of claim 1 further comprising burning an alternative fuel with the DDGS in the biomass burner and controlling the ratio of the two fuels.

4. A method of using a DDGS by-product of an ethanol plant as an energy source, the method comprising:
loading said DDGS into a biomass burner; and
burning said DDGS to release thermal energy.

5. A system for converting DDGS energy into thermal energy for the production of ethanol, the system comprising:
a vessel for heating a mixture of water and fermentable material to form a cooked mash;
a vessel for fermenting the cooked mash to form beer;
a vessel for distilling the beer to produce ethanol vapor and stillage;
a vessel for dehydrating ethanol to produce anhydrous ethanol;
a dryer for drying the stillage;
a storage bin for storing the dried stillage;
a blower for introducing air and the dried stillage for combustion;
a burner for combusting biomass material; and
a boiler for supplying steam by burning the dried stillage.
